(19) United States
(12) Patent Application Publication
(10) Pub. No.: US 2025/0148690 A1
(43) Pub. Date: May 8, 2025

(54) INFORMATION PROCESSING METHOD, INFORMATION PROCESSING DEVICE, AND NON-TRANSITORY COMPUTER READABLE RECORDING MEDIUM

(71) Applicant: PANASONIC INTELLECTUAL PROPERTY MANAGEMENT CO., LTD., Osaka (JP)

(72) Inventors: Minami NAKA, Osaka (JP); Tadamasa TOMA, Osaka (JP); Satoshi MATSUI, Kyoto (JP)

(73) Assignee: PANASONIC INTELLECTUAL PROPERTY MANAGEMENT CO., LTD., Osaka (JP)

(21) Appl. No.: 19/019,031

(22) Filed: Jan. 13, 2025

Related U.S. Application Data
(63) Continuation of application No. PCT/JP2023/025988, filed on Jul. 14, 2023.
(60) Provisional application No. 63/368,821, filed on Jul. 19, 2022.

(30) Foreign Application Priority Data
Jun. 13, 2023 (JP) 2023-097278

(51) Int. Cl. G06T 15/04; G06F 3/14; G06T 5/80; G06T 7/80; G06V 10/25

(52) U.S. Cl. CPC G06T 15/04; G06F 3/14; G06T 5/80; G06T 7/80; G06V 10/25; G06T 2207/30244; G06V 2201/07

(57) ABSTRACT

An information processing device acquires a three-dimensional object by reproducing a real object including a dynamic region in a virtual space, identifies a first dynamic region indicating the dynamic region in the three-dimensional object, acquires a real image of the real object captured by an imaging device, detects a second dynamic region indicating the dynamic region in the real image, embeds an image of the second dynamic region in real time as a texture image of the first dynamic region, and outputs a display image of the three-dimensional object in which the image of the second dynamic region has been embedded.

### FIELD OF INVENTION

The present disclosure relates to a technique for updating a three-dimensional object.

### BACKGROUND ART

Patent Literature 1 discloses a three-dimensional (3D) model generation device that generates a 3D model of a subject with a volume intersection method based on camera videos of a zoom-in camera and a zoom-out camera, and in this device, the 3D model is generated assuming that the subject exists outside an angle of view range of the zoom-in camera.

However, in Patent Literature 1, since inclusion of a dynamic region in a three-dimensional object is not considered, the dynamic region of the three-dimensional object cannot be updated in real time.
Patent Literature 1: JP 2022-29730 A

### SUMMARY OF THE INVENTION

The present disclosure has been made to solve such a problem, and an object thereof is to provide a technique capable of updating a dynamic region included in a three-dimensional object in real time.

An information processing method according to one aspect of the present disclosure is an information processing method in a computer, the method including acquiring a three-dimensional object by reproducing a real object including a dynamic region in a virtual space, identifying a first dynamic region indicating the dynamic region in the three-dimensional object, acquiring a real image of the real object captured by an imaging device, detecting a second dynamic region indicating the dynamic region in the real image, embedding an image of the second dynamic region in real time as a texture image of the first dynamic region, and outputting a display image of the three-dimensional object in which the image of the second dynamic region has been embedded.

According to the present disclosure, the dynamic region included in the three-dimensional object can be updated in real time.

### BRIEF DESCRIPTION OF THE DRAWINGS

FIG. 1 is an overall configuration diagram of an information processing system according to a first embodiment.

FIG. 2 is a diagram illustrating an example of target equipment.

FIG. 3 is a flowchart illustrating an example of processing for generating a three-dimensional object in the first embodiment of the present disclosure.

FIG. 4 is a flowchart illustrating one example of updating processing according to the first embodiment.

FIG. 5 is a flowchart illustrating details of processing for detecting a second dynamic region shown in step S13 in FIG. 4.

FIG. 6 is a flowchart illustrating details of processing for updating a first dynamic region shown in step S14 in FIG. 4.

FIG. 7 is a diagram illustrating one example of an initial texture image including the second dynamic region captured during generating the three-dimensional object.

FIG. 8 is a diagram illustrating one example of a real image including the second dynamic region captured by a camera.

FIG. 9 is a diagram illustrating a state where an image of the second dynamic region is embedded in the first dynamic region.

FIG. 10 is a flowchart illustrating one example of processing for generating a three-dimensional object in a second embodiment.

FIG. 11 is a flowchart illustrating details of processing for updating a first dynamic region in the second embodiment.

FIG. 12 is a diagram illustrating one example of an initial texture image.

FIG. 13 is a diagram illustrating a state where an image of the second dynamic region is embedded in the first dynamic region in the second embodiment.

### DETAILED DESCRIPTION

Hereinafter, embodiments of the present disclosure will be described with reference to the accompanying drawings. Note that the following embodiments are examples embodying the present disclosure, and are not intended to limit a technical scope of the present disclosure.

### (Knowledge Underlying Present Disclosure)

When a worker performs a work on a target object at a work site, the worker may proceed with the work while checking an instruction from a remote person outside the work site. In this case, if the remote person can check which part of the target object the worker is looking at, the remote person can smoothly instruct the worker. In order to achieve this situation, for example, when an imaging device such as an action camera or a smart glass is attached to the head of the worker and a video of the work site captured by the imaging device is transmitted in real time to a remote terminal of the remote person, the remote person can check which part of the target object the worker is looking at.

However, at some work sites, a video is prohibited to be output to the outside from the viewpoint of security. In this case, there is a problem that the remote person cannot check the portion looked at by the worker.

Therefore, the present inventor has studied a technique for synchronizing the position and posture of the worker at the site with the position and attitude of a virtual camera to generate a virtual camera video obtained by reproducing the field of view of the worker at the site in a virtual space, and displaying the generated virtual camera video on a remote terminal of a remote person.

An object may include a dynamically changing object element, such as a monitor. Hereinafter, a region indicating the object element is referred to as a dynamic region. In a case where the object is reproduced in a three-dimensional virtual space, if the dynamic region is updated in real time, the remote person can more accurately know the situation at the site. A three-dimensional object is generated by embedding an image representing a surface of a target object in a three-dimensional model indicating a three-dimensional shape of the target object.

Therefore, the present inventor has found that a three-dimensional object generated by reproducing a dynamic region real time can be obtained by identifying the dynamic region in the three-dimensional object obtained by reproducing a real object in the virtual space, detecting the dynamic region in a real image of the target object captured by a camera in real time, and embedding, in the dynamic region of the three-dimensional object, an image of the dynamic region detected in the real image, and has arrived at the present disclosure.

(1) An information processing method according to one aspect of the present disclosure is an information processing method in a computer, the method including acquiring a three-dimensional object by reproducing a real object including a dynamic region in a virtual space, identifying a first dynamic region indicating the dynamic region in the three-dimensional object, acquiring a real image of the real object captured by an imaging device, detecting a second dynamic region indicating the dynamic region in the real image, embedding an image of the second dynamic region in real time as a texture image of the first dynamic region, and outputting a display image of the three-dimensional object in which the image of the second dynamic region has been embedded.

According to this configuration, the image of the second dynamic region detected in the real image captured by the imaging device is embedded in the first dynamic region of the three-dimensional object in real time. Therefore, the dynamic region included in the three-dimensional object can be updated in real time.

(2) In the information processing method according to (1), the real object may have a marker indicating the dynamic region, the identifying the first dynamic region may include detecting the first dynamic region based on the marker in the three-dimensional object, and the detecting the second dynamic region may include detecting the second dynamic region based on an image indicating the marker included in the real image.

According to this configuration, since the real object has the marker, the first dynamic region and the second dynamic region can be accurately detected using the marker as a guide.

(3) In the information processing method according to (1), the dynamic region may correspond to an object element constituting the real object, the identifying the first dynamic region may include detecting a region of the object element in the three-dimensional object with object recognition processing, and the detecting the second dynamic region may include detecting a region of the object element in the real image with the object recognition processing.

According to this configuration, since the first dynamic region and the second dynamic region are detected with the object recognition processing, the first dynamic region and the second dynamic region can be accurately detected.

(4) In the information processing method according to any one of (1) to (3), the real image may be repeatedly acquired, and the detecting, the embedding, and the outputting of the second dynamic region may be performed each time the real image is acquired.

According to this configuration, the first dynamic region can be updated with the image of the second dynamic region each time the real image is acquired.

(5) In the information processing method according to any one of (1) to (4), the embedding the image of the second dynamic region may include acquiring a distortion parameter of the imaging device, correcting distortion of the image of the second dynamic region using the distortion parameter, and embedding the image of the second dynamic region after the correcting in the first dynamic region.

According to this configuration, since the image of the second dynamic region subjected to distortion correction is embedded in the first dynamic region, the image of the second dynamic region can be embedded in the first dynamic region without feeling of strangeness even in a case where the real image is captured at any position and attitude.

(6) In the information processing method according to (5), the distortion parameter may be estimated by camera calibration using current position and attitude information about the imaging device, initial position and attitude information about the imaging device at a time of capturing an initial texture image embedded in the first dynamic region, two-dimensional position information about the dynamic region in the initial texture image, two-dimensional position information about the second dynamic region in the real image, and three-dimensional position information about the first dynamic region.

According to this configuration, since the distortion parameter is estimated using the camera calibration, the distortion of the image of the second dynamic region can be accurately corrected using the distortion parameter.

(7) In the information processing method according to (6), the current position and attitude information about the imaging device may be estimated by applying a self-position estimation algorithm to the initial texture image and the real image.

According to this configuration, the current position and attitude information about the imaging device can be calculated without using an external sensor.

(8) In the information processing method according to any one of (1) to (4), the embedding the image of the second dynamic region may include editing the image of the second dynamic region to match with a shape of the first dynamic region, based on two-dimensional position information about a vertex of the second dynamic region and two-dimensional position information about a vertex of the first dynamic region, and embedding the edited image of the second dynamic region in the first dynamic region.

According to this configuration, the image of the second dynamic region can be embedded in the first dynamic region without feeling of strangeness without using the three-dimensional position information.

(9) In the information processing method according to any one of (1) to (8), the dynamic region may include a region corresponding to a display region of a monitor included in the real object.

According to this configuration, the image of the first dynamic region can be changed in accordance with the change in the image displayed on the monitor included in the real object.

(10) An information processing device according to another aspect of the present disclosure is an information processing device including a processor, in which the processor acquires a three-dimensional object by reproducing a real object including a dynamic region in a virtual space, identifies a first dynamic region indicating the dynamic region in the three-dimensional object, acquires a real image of the real object captured by an imaging device, detects a second dynamic region indicating the dynamic region in the real image, embeds an image of the second dynamic region in real time as a texture image of the first dynamic region, and outputs a display image of the three-dimensional object in which the image of the second dynamic region has been embedded.

This configuration can provide the information processing device that updates the dynamic region included in the three-dimensional object in real time.

(11) An information processing program according to another aspect of the present disclosure causes a computer to perform processing of: acquiring a three-dimensional object by reproducing a real object including a dynamic region in a virtual space, identifying a first dynamic region indicating the dynamic region in the three-dimensional object, acquiring a real image of the real object captured by an imaging device, detecting a second dynamic region indicating the dynamic region in the real image, embedding an image of the second dynamic region in real time as a texture image of the first dynamic region, and outputting a display image of the three-dimensional object in which the image of the second dynamic region has been embedded.

This configuration can provide the information processing program that updates the dynamic region included in the three-dimensional object in real time.

The present disclosure can be also implemented as an information processing program or an information processing system that is operated by the information processing program. It is needless to say that such a computer program can be distributed via a computer-readable non-transitory recording medium such as a CD-ROM, or via a communication network such as the Internet.

Each of embodiments to be described below illustrates a specific example of the present disclosure. Numerical values, shapes, components, steps, an order of steps, and the like described in the embodiments below are examples, and are not intended to limit the present disclosure. Further, a component that is not described in an independent claim representing the highest concept among components in the embodiments below will be described as any component. Further, in all the embodiments, content of each of the embodiments can be combined.

### First Embodiment

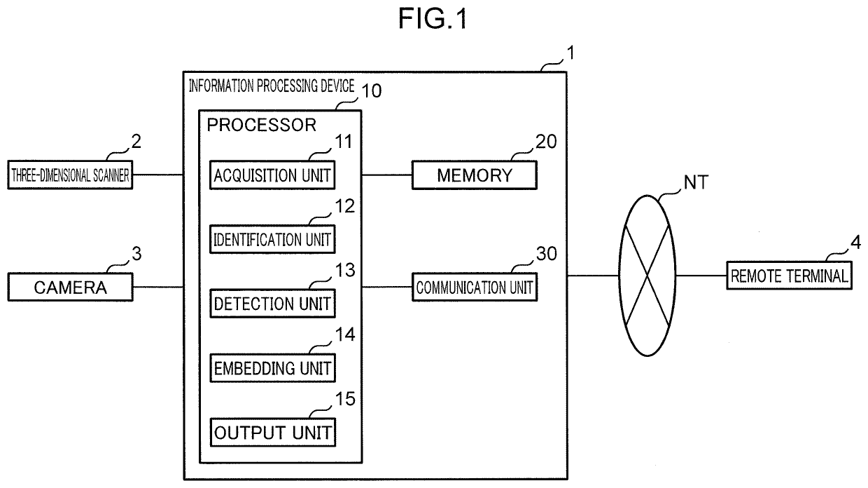

FIG. 1 is an overall configuration diagram of an information processing system according to a first embodiment. The information processing system includes an information processing device 1, a three-dimensional scanner 2, a camera 3, and a remote terminal 4. The information processing device 1 includes a computer. The information processing device 1 and the remote terminal 4 are communicably connected to each other via a network NT. The network NT is, for example, the Internet. The three-dimensional scanner 2 and the camera 3 are communicably connected to each other via a wireless or wired communication path. Examples of the communication path include a wireless local area network (LAN), a wired LAN, and Bluetooth (registered trademark). The three-dimensional scanner 2 and the camera 3 exist at a site where target equipment (an example of a real object) with which a worker performs work is installed. The information processing device 1 may be disposed on the edge side including the site or may be disposed on the cloud side. In a case where the information processing device 1 is disposed on the cloud side, the communication path includes the network NT.

The site is, for example, a real space where the target equipment is installed. Examples of the site include a factory, an experiment site, a test site, and a chemical plant. The factory may be a factory where electrical products such as televisions and washing machines are manufactured, or may be a factory where automobiles, iron, and the like are manufactured. These sites are examples, and may be any place as long as a worker performs a work on the target equipment. For example, the site may be a place where maintenance of devices or equipment is performed. Examples of the target equipment include a manufacturing line of a factory. Here, the facility has been exemplified as an example of the real object, but the real object may be a product or the like manufactured on a manufacturing line. Examples of the product include an electrical appliance and an automobile. The target equipment includes a dynamic region. The dynamic region is a region whose state changes over time, such as a display region of a monitor.

The three-dimensional scanner 2 acquires three-dimensional data of the target equipment by scanning the target equipment. The three-dimensional scanner 2 is, for example, a laser beam type three-dimensional scanner that irradiates an object with a line laser beam and receives reflected light from the object to acquire three-dimensional point cloud data of the object. The three-dimensional scanner 2 outputs the point cloud data acquired by scanning the target equipment to the information processing device 1. Further, the three-dimensional scanner 2 includes a camera for capturing a texture image of an object, and outputs the texture image of the target equipment acquired by the camera to the information processing device 1. The three-dimensional scanner 2 and the camera 3 are examples of the imaging device. Here, the camera of the three-dimensional scanner 2 images the target equipment from a plurality of directions. A portable three-dimensional scanner carried by a measurer is adopted as the three-dimensional scanner 2, but this is an example, and the three-dimensional scanner 2 may be an installation type three-dimensional scanner.

The camera 3 includes, for example, a portable camera attached to a worker who performs work on target equipment. However, this is an example, and the camera 3 may be configured by a camera included in a portable terminal carried by a worker or by an installation type camera. The camera 3 images the target equipment at a predetermined frame rate, and transmits the acquired real image of the target equipment to the information processing device 1.

The remote terminal 4 is a terminal that is owned by a remote person and installed at a remote place. The remote terminal 4 is configured by a computer including a display and a communication circuit. The remote terminal 4 may be a stationary computer or a portable computer.

The information processing device 1 includes a processor 10, a memory 20, and a communication unit 30. The processor 10 is, for example, a central processing unit (CPU). The processor 10 includes an acquisition unit 11, an identification unit 12, a detection unit 13, an embedding unit 14, and an output unit 15.

The acquisition unit 11 acquires a three-dimensional object by reproducing the target equipment including the dynamic region in the virtual space. Here, the acquisition unit 11 acquires the point cloud data of the target equipment transmitted from the three-dimensional scanner 2 using the communication unit 30, and generates a three-dimensional object of the target equipment from the acquired point cloud data. The three-dimensional object is three-dimensional data generated by embedding a texture image captured by the camera of the three-dimensional scanner 2 in a three-dimensional model indicating the three-dimensional shape of the target equipment. The virtual space is a virtual three-dimensional space constructed in a computer.

In the present embodiment, a plurality of markers indicating a dynamic region is placed at a boundary portion of the dynamic region in the target equipment. Therefore, even in the three-dimensional object, a plurality of markers is placed at a boundary portion of the dynamic region.

The identification unit 12 identifies a first dynamic region indicating the dynamic region in the three-dimensional object acquired by the acquisition unit 11. Here, the identification unit 12 identifies the first dynamic region by detecting the plurality of markers displayed on the three-dimensional object. Alternatively, the identification unit 12 may identify the first dynamic region by reading, from the memory 20, the three-dimensional position information about the plurality of markers detected during the generating of the three-dimensional object.

The detection unit 13 acquires the real image of the target equipment captured by the camera 3 using the communication unit 30, and detects the second dynamic region indicating the dynamic region in the acquired real image. Here, the detection unit 13 detects the second dynamic region by detecting the plurality of markers appearing in the real image. In addition, the detection unit 13 detects the second dynamic region every time the acquisition unit 11 acquires the real image, that is, in real time.

The embedding unit 14 embeds the image of the second dynamic region in real time as the texture image of the first dynamic region identified by the identification unit 12. Embedding in real time refers to, for example, embedding the image of the second dynamic region in the first dynamic region in synchronization with a frame rate of the camera 3. However, this is an example, and the embedding in real time may refer to embedding the image of the second dynamic region in the first dynamic region at a constant time interval obtained by thinning the frame rate.

The output unit 15 outputs the display image of the three-dimensional object in which the image of the second dynamic region has been embedded. Here, the output unit 15 may generate a display image by performing rendering for imaging a three-dimensional object by a virtual camera installed in a virtual space in real time. The output unit 15 generates display data for displaying the generated display image on the remote terminal 4, and outputs the generated display data to the remote terminal 4 using the communication unit 30. As a result, the display image of the three-dimensional object is displayed on the display of the remote terminal 4. Therefore, the information processing device 1 can make the remote person to check the situation of the target equipment in real time without transmitting the real image of the target equipment. The position and attitude of the virtual camera can be optionally changed in accordance with an instruction transmitted from the remote terminal 4. As a result, the remote person can check the situation of the target equipment from an any direction through the three-dimensional object.

The memory 20 is configured with a nonvolatile rewritable storage device such as a solid state drive or a hard disk drive. The memory 20 stores the three-dimensional object generated by the acquisition unit 11. The memory 20 stores three-dimensional position information and attitude information about the camera of the three-dimensional scanner 2 that has captured the texture image during the generation of the three-dimensional object.

The communication unit 30 includes a communication circuit that connects the information processing device 1 to the network NT. The communication unit 30 transmits the display data of the three-dimensional object to the remote terminal 4. The communication unit 30 receives the point cloud data and the texture image from the three-dimensional scanner 2. The communication unit 30 receives the real image captured by the camera 3 in real time. The communication unit 30 receives an instruction to set the position and attitude of the virtual camera from the remote terminal 4.

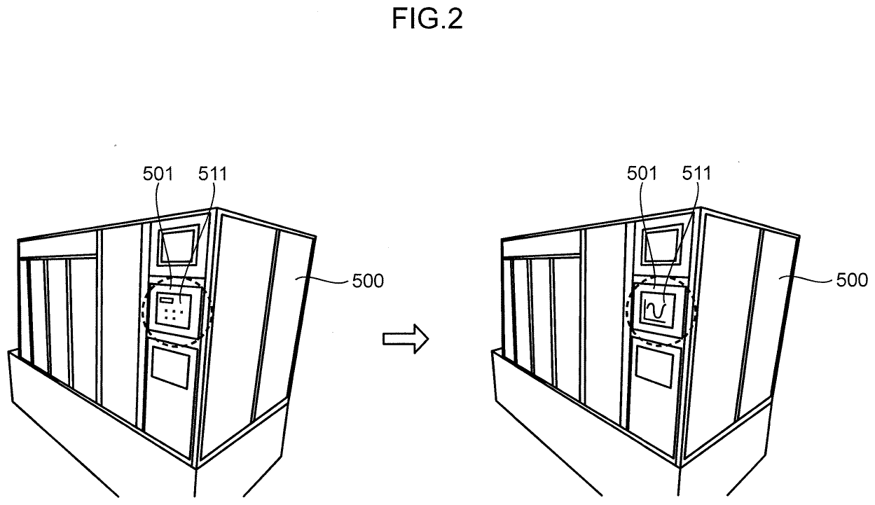

FIG. 2 is a diagram illustrating an example of target equipment 500. The target equipment 500 is equipment having a housing including a frame. A monitor 501 is attached to the surface of the target equipment 500. The monitor 501 displays a monitor screen 511 indicating information about the target equipment 500, such as a state of the target equipment 500. The monitor screen 511 changes over time as illustrated from the left diagram to the right diagram in FIG. 2. In a case where a three-dimensional object is generated at the time of the left diagram in FIG. 2, even if the monitor screen 511 changes as illustrated in the right diagram of FIG. 2, the remote person cannot check the state of the monitor screen 511 of the target equipment 500 in real time unless the contents of the monitor screen 511 are reflected in the three-dimensional object. Therefore, in the present embodiment, an image on the monitor screen 511 is cut out from the real image captured by the camera 3, and the cut image is embedded in a region of the monitor 501 in the three-dimensional object in real time. As a result, the remote person can check the contents of the monitor screen 511 in real time.

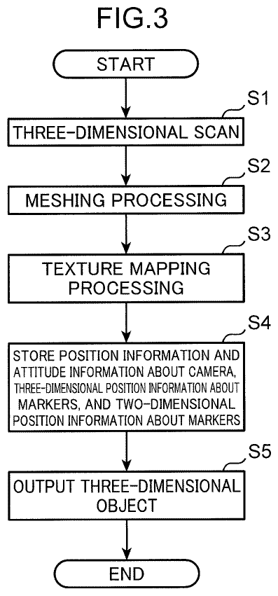

FIG. 3 is a flowchart illustrating one example of the processing for generating the three-dimensional object in the first embodiment of the present disclosure.

In step S1, the three-dimensional scanner 2 scans the target equipment 500. As a result, the acquisition unit 11 acquires the point cloud data of the target equipment 500 and the plurality of texture images from the three-dimensional scanner 2.

In next step S2, the acquisition unit 11 generates a three-dimensional model from the point cloud data, and performs meshing processing for representing the surface of the generated three-dimensional model with a plurality of meshes.

In next step S3, the acquisition unit 11 generates a three-dimensional object by performing texture mapping processing for embedding a texture image in the meshed three-dimensional model. For example, the acquisition unit 11 may acquire three-dimensional position information and attitude information about the three-dimensional scanner 2 with respect to the target equipment 500 at a time of capturing the texture image from the three-dimensional scanner 2, and may embed the plurality of texture images in the three-dimensional model using the acquired three-dimensional position information and attitude information.

For the first dynamic region, the acquisition unit 11 may identify a texture image that most satisfies a predetermined condition among the plurality of texture images obtained by imaging the dynamic region, and may embed the identified texture image in the first dynamic region. Hereinafter, the texture image to be embedded during generating the three-dimensional object is referred to as an initial texture image.

The predetermined condition includes a condition related to the imaging distance and a condition related to the imaging direction. The imaging distance refers to a distance from the three-dimensional scanner 2 to a plurality of markers, and the shorter the imaging distance is, the higher the satisfaction level of the condition regarding the imaging distance becomes. The imaging direction refers to the imaging direction of the three-dimensional scanner 2, and the closer the imaging direction is to the front direction of the markers, the higher the satisfaction level of the condition regarding the imaging direction becomes.

The acquisition unit 11 may identify, among the plurality of texture images obtained by imaging the dynamic region, the texture image in which the sum of the satisfaction level of the condition regarding the imaging distance and the satisfaction level of the condition regarding the imaging direction is the largest as the image satisfying the predetermined condition. As a result, the texture image obtained by imaging the marker with the highest accuracy is embedded in the first dynamic region, as the initial texture image. Note that the predetermined condition may be any one of the condition regarding the imaging distance and the condition regarding the imaging direction.

In next step S4, the acquisition unit 11 stores, in the memory 20, camera position information indicating the position and attitude information indicating the attitude of the three-dimensional scanner 2 during the capturing of the initial texture image embedded in the first dynamic region, three-dimensional position information about each of the plurality of markers, and two-dimensional position information indicating the position of each of the plurality of markers in the initial texture image. Hereinafter, the camera position information and the attitude information during the capturing of the initial texture image are referred to as initial camera position information and initial attitude information.

In next step S5, the acquisition unit 11 outputs the generated three-dimensional object. Here, the acquisition unit 11 may output the generated three-dimensional object to the memory 20.

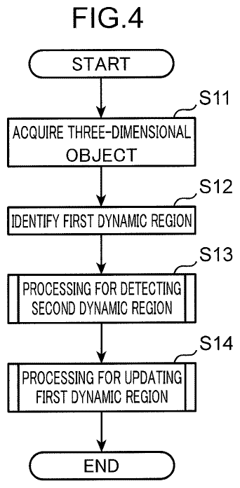

FIG. 4 is a flowchart illustrating one example of updating processing according to the first embodiment. In step S11, the acquisition unit 11 acquires a three-dimensional object from the memory 20.

In next step S12, the identification unit 12 identifies the first dynamic region. Here, the identification unit 12 may detect the plurality of markers placed on the three-dimensional object by applying pattern matching to the three-dimensional object, and may identify a region surrounded by the plurality of detected markers as the first dynamic region.

For example, in a case where the plurality of markers is placed at positions of four vertexes of a quadrangular monitor, the identification unit 12 may identify the quadrangular region surrounded by these four markers as the first dynamic region. The number of markers placed in the target equipment 500 may be three or two. In a case where the number of markers is three, a quadrangular region defined by the three markers is identified as the first dynamic region. In a case where the number of markers is two, the two markers are placed at two opposite vertexes of the quadrangular dynamic region. Therefore, in the case where the number of markers is two, the quadrangular region defined by the two markers is identified as the first dynamic region. Here, the first dynamic region has a quadrangular shape, but this is an example, and may have a polygonal shape such as a triangular, pentagonal, or hexagonal shape. In this case, the markers whose number is in accordance with the shape of the first dynamic region are placed.

In step S12, the identification unit 12 may identify the first dynamic region using the three-dimensional position information about the markers stored in the memory 20 in step S4 of FIG. 3.

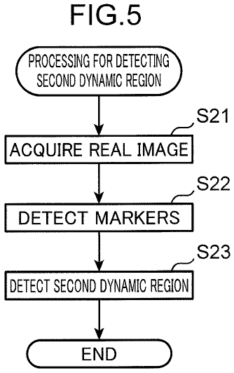

In next step S13, the detection unit 13 performs processing for detecting the second dynamic region in the real image captured by the camera 3. Details of this processing will be described later with reference to FIG. 5.

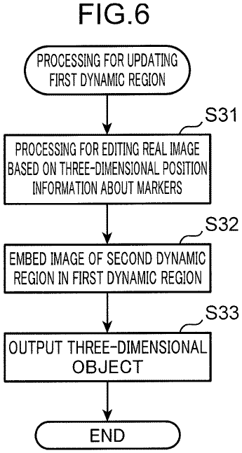

In next step S14, the embedding unit 14 performs updating processing for updating the first dynamic region with the image of the second dynamic region. Details of this processing will be described later with reference to FIG. 6. Note that the processing in steps S13 and S14 is repeatedly performed. As a result, the image of the second dynamic region is embedded in the first dynamic region in real time.

FIG. 5 is a flowchart illustrating details of processing for detecting the second dynamic region shown in step S13 of FIG. 4. In step S21, the detection unit 13 acquires the real image captured by the camera 3 using the communication unit 30.

In next step S22, the detection unit 13 detects the plurality of markers in the real image by performing pattern matching using the images of the markers as a template.

In next step S23, the detection unit 13 detects a region surrounded by the plurality of detected markers as the second dynamic region. Since the details of this processing are the same as the processing for the identification unit 12 detecting the first dynamic region based on the plurality of markers, the detailed description will be omitted.

FIG. 6 is a flowchart illustrating details of processing for updating the first dynamic region shown in step S14 of FIG. 4.

In step S31, the embedding unit 14 performs processing for editing the real image based on the three-dimensional position information about each of the plurality of markers. Details of this processing will be described later.

In next step S32, the embedding unit 14 embeds the edited image of the second dynamic region in the first dynamic region.

In next step S33, the output unit 15 generates a display image of the three-dimensional object in which the first dynamic region has been updated, and transmits display data of the generated display image to the remote terminal 4 using the communication unit 30. As a result, the display image of the three-dimensional object is displayed on the display of the remote terminal 4.

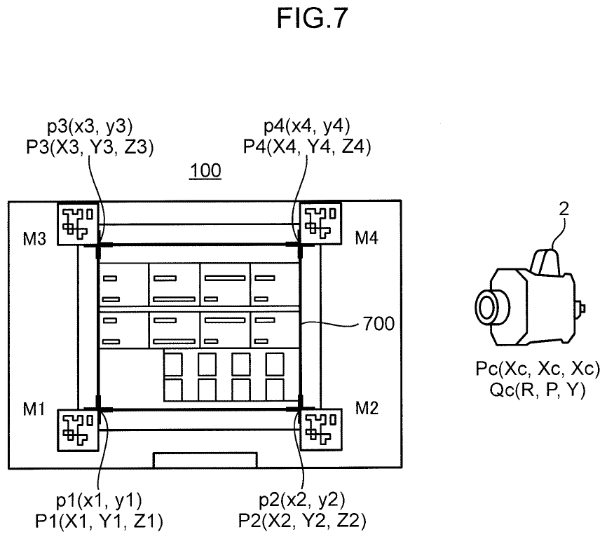

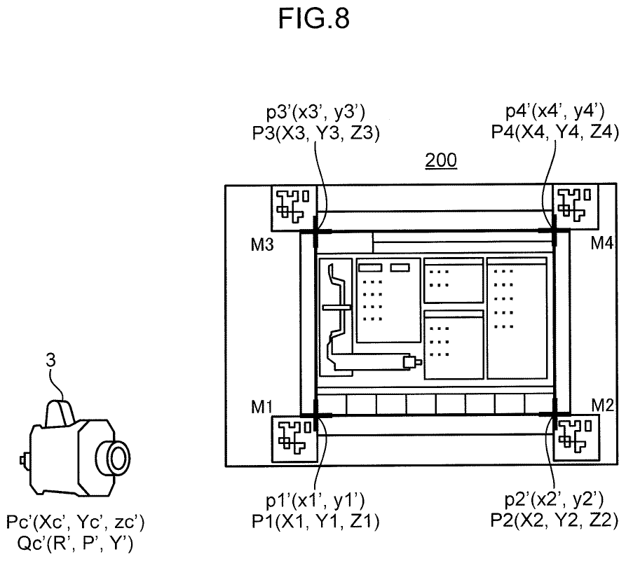

Hereinafter, details of the real image editing processing shown in step S31 of FIG. 6 will be described with reference to FIGS. 7 and 8. FIG. 7 is a diagram illustrating one example of an initial texture image 100 including the dynamic region, the initial texture image being captured during generating the three-dimensional object. The initial texture image 100 includes four markers M1 to M4. The markers M1 to M4 are two-dimensional markers in which a predetermined dot pattern is drawn on their surfaces. The same dot pattern is drawn on each of the markers M1 to M4. A quadrangular region surrounded by the markers M1 to M4 is a dynamic region 700. Reference signs P1 to P4 are three-dimensional position information indicating the three-dimensional positions of the markers M1 to M4. Reference signs p1 to p4 are two-dimensional position information indicating the positions of the markers M1 to M4 in the initial texture image. Three-dimensional position information P is represented by three coordinate components of X, Y, and Z. For example, in the three-dimensional position information P1, the X, Y, and Z components are respectively represented by coordinate components of X1, Y1, and Z1, respectively. Two-dimensional position information p is represented by two coordinate components of x and y. For example, the two-dimensional position information p1 is represented by two coordinate components of x1 and y1.

The three-dimensional position information P1 to P4 and the two-dimensional position information p1 to p4 are acquired during the generation of the three-dimensional object. Initial camera position information Pc indicates the three-dimensional position of the three-dimensional scanner 2 during the capturing of the initial texture image. Initial attitude information Qc indicates the attitude of the three-dimensional scanner 2 during the capturing of the initial texture image. The initial attitude information Qc is represented by three components of roll R, pitch P, and yaw Y.

FIG. 8 is a diagram illustrating one example of a real image 200 including the second dynamic region captured by the camera 3. Two-dimensional position information p1′ to p4′ is two-dimensional position information indicating the positions of the markers M1 to M4 in the real image 200. The two-dimensional position information p1′ to p4′ is detected when the markers M1 to M4 are detected by the detection unit 13. Since the target equipment 500 is fixed in the real space, the three-dimensional position information P1 to P4 is the same as the three-dimensional position information P1 to P4 in FIG. 7. Camera position information Pc′ indicates a three-dimensional position of the current camera during capturing the real image 200. Attitude information Qc′ indicates an attitude of the camera during capturing the real image 200. The camera position information Pc′ and the attitude information Qc′ are unknown.

In the real image editing processing, first, the embedding unit 14 estimates the camera position information Pc′ and the attitude information Qc′ by applying a self-position estimation algorithm to the initial texture image 100 and the real image 200. An example of the self-position estimation algorithm is Simultaneous Localization and Mapping (SLAM). Specifically, the embedding unit 14 detects feature points in the initial texture image 100 and the real image 200, and performs matching between the detected feature points. An algorithm such as Scale-Invariant Feature Transform (SIFT) is used to detect the feature points. The embedding unit 14 then may obtain the movement amount and the rotation amount of the camera based on the matching result, and may estimate the camera position information Pc′ and the camera attitude information Qc′ using the obtained movement amount and rotation amount, the initial camera position information Pc, and the initial attitude information Qc.

Next, the embedding unit 14 performs camera calibration using the estimated camera position information Pc′ and attitude information Qc′, the initial camera position information Pc, the initial attitude information Qc, the three-dimensional position information P1 to P4 about the markers M1 to M4, the two-dimensional position information p1 to p4 about the markers M1 to M4, and the two-dimensional position information p1′ to p4′ about the markers M1 to M4, and estimates a distortion parameter of the camera 3.

As the camera calibration, camera calibration using a camera model can be adopted. The camera model is a model representing a relationship between two-dimensional coordinates on an image and three-dimensional coordinates of a real space corresponding to the two-dimensional coordinates using camera parameters. The camera parameters include an external parameter, an internal parameter, and a distortion parameter.

Next, the embedding unit 14 performs distortion correction for removing distortion from the real image 200 using the estimated distortion parameter. As a result, the distortion is removed, and the real image 200 edited with the size matching with the size of the first dynamic region is acquired.

The embedding unit 14 then cuts out an image of the dynamic region 700 from the real image 200 that has been subject to the distortion correction. This image is the image of the second dynamic region. The embedding unit 14 then embeds the image of the second dynamic region in the first dynamic region of the three-dimensional object.

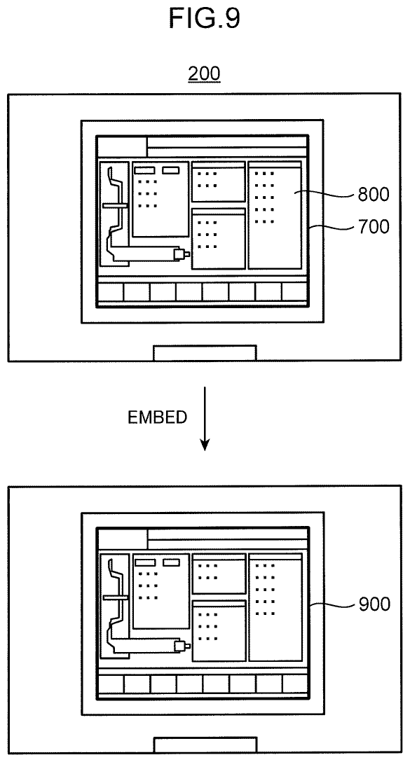

FIG. 9 is a diagram illustrating a state where an image 800 of the second dynamic region is embedded in a first dynamic region 900. The upper part of FIG. 9 is a diagram illustrating the real image 200 that has been subject to the distortion correction. The embedding unit 14 cuts out the image of the dynamic region 700 as the image 800 of the second dynamic region from the real image 200 that has been subject to the distortion correction. Then, as illustrated in the lower part of FIG. 9, the embedding unit 14 embeds the cut-out image 800 of the second dynamic region in the first dynamic region 900 of the three-dimensional object. As a result, the image 800 of the second dynamic region included in the real image 200 captured at any position and attitude, the image 800 being different from the initial texture image 100, can be accurately embedded in the first dynamic region 900.

As described above, according to the first embodiment, the image of the second dynamic region detected in the real image 200 captured by the camera 3 is embedded in the first dynamic region identified from the three-dimensional object in real time. Therefore, the texture image of the dynamic region included in the three-dimensional object can be updated in real time.

### Second Embodiment

In a second embodiment, the image 800 of the second dynamic region is embedded in the first dynamic region 900 without using the three-dimensional position information about the markers M1 to M4. In the second embodiment, the same components as those in the first embodiment are denoted by the same reference numerals, and description thereof will be omitted. FIG. 1 is used as a block diagram in the second embodiment. In the method of the second embodiment, the image 800 of the second dynamic region is embedded using not the three-dimensional position information P1 to P4 of the markers M1 to M4 but the two-dimensional position information p1 to p4 and p1′ to p4′. Therefore, it is assumed that the initial texture image 100 and the real image 200 are images obtained by imaging the dynamic region 700 of the target equipment from the front to some extent.

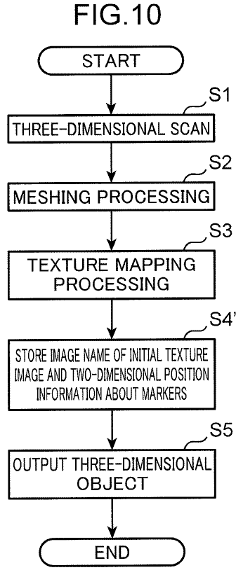

FIG. 10 is a flowchart illustrating one example of processing for generating the three-dimensional object in the second embodiment. A difference in FIG. 10 from FIG. 3 is step S4′. In step S4′, the acquisition unit 11 stores the image name of the initial texture image 100 and the two-dimensional position information p1 to p4 about the markers M1 to M4 in the memory 20. Here, the three-dimensional object is configured to be able to identify a region where the initial texture image 100 is embedded using the image name of the initial texture image 100 as a key.

In the second embodiment, the updating processing is basically the same as that in FIG. 4, but the processing for identifying the first dynamic region shown in step S12 is different from the processing for updating the first dynamic region shown in step S14. Thus, these processing will be described below. In the second embodiment, since the processing for detecting the second dynamic region shown in step S13 of FIG. 4 is the same as the processing for detecting the second dynamic region in the first embodiment shown in FIG. 5, the description thereof will be omitted.

In step S12 shown in FIG. 4, the identification unit 12 identifies the initial texture image 100 using the image name of the initial texture image stored in the memory 20 in step S4′ of FIG. 10 as a key, and identifies the first dynamic region by detecting the two-dimensional position information p1 to p4 about the markers M1 to M4 in the initial texture image 100. Alternatively, the identification unit 12 may identify the first dynamic region by acquiring the two-dimensional position information p1 to p4 about the markers M1 to M4 stored in the memory 20 in step S4′ of FIG. 10.

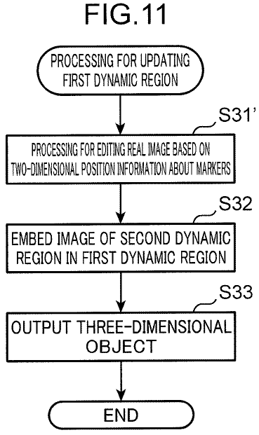

FIG. 11 is a flowchart illustrating details of the processing for updating the first dynamic region in the second embodiment. A difference in FIG. 11 from FIG. 6 is step S31′. In step S31′, the embedding unit 14 performs the processing for editing the real image based on the two-dimensional position information p1 to p4 about the markers M1 to M4.

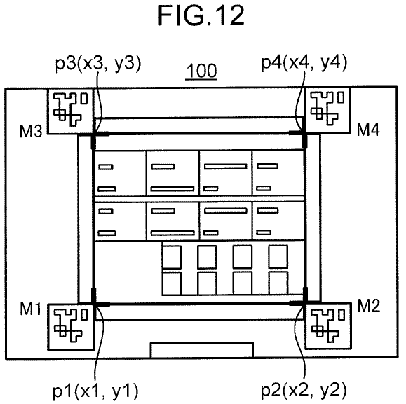

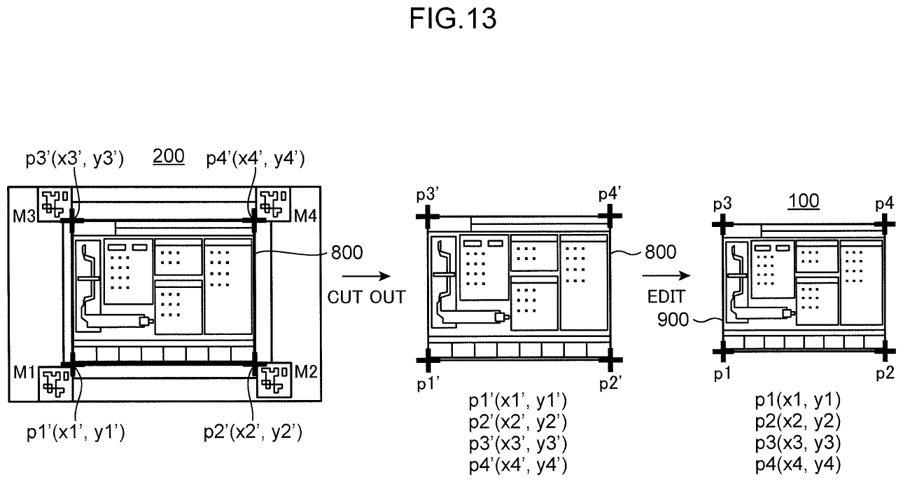

The real image editing processing based on the two-dimensional position information will be described below with reference to FIGS. 12 and 13. FIG. 12 is a diagram illustrating one example of the initial texture image 100. FIG. 12 differs from FIG. 7 in that the three-dimensional position information P1 to P4, the initial camera position information Pc, and the initial attitude information Qc are not used in the second embodiment, and thus illustration thereof is omitted. In the second embodiment, since the two-dimensional position information p1 to p4 about the markers M1 to M4 is used, FIG. 12 illustrates the two-dimensional position information p1 to p4. The two-dimensional position information p1 to p4 is acquired during generating the three-dimensional object.

FIG. 13 is a diagram illustrating a state where the image 800 of the second dynamic region is embedded in the first dynamic region 900 in the second embodiment. The left part of FIG. 13 illustrates the real image 200 including the second dynamic region captured by the camera 3. The detection unit 13 detects the markers M1 to M4 by applying pattern matching to the real image 200, and detects the position information about the detected markers M1 to M4 as the two-dimensional position information p1′ to p4′.

Next, the embedding unit 14 cuts out the image 800 of the second dynamic region surrounded by the two-dimensional position information p1′ to p4′ from the real image 200. As a result, the image 800 of the second dynamic region is cut out from the real image 200 as illustrated in the center part of FIG. 13.

The embedding unit 14 then reads the initial texture image 100 and the two-dimensional position information p1 to p4 about the markers M1 to M4 from the memory 20 using the image name of the initial texture image.

The embedding unit 14 then edits the image 800 of the second dynamic region so that the two-dimensional position information p1′ to p4′ located at the vertexes of the second dynamic region fits to the two-dimensional position information p1 to p4 in the initial texture image 100 illustrated on the right part of FIG. 13. The embedding unit 14 may edit the image 800 of the second dynamic region by, for example, affine transformation.

The embedding unit 14 then embeds the edited image 800 of the second dynamic region in the first dynamic region 900 of the three-dimensional object. In this case, the embedding unit 14 may identify the region of the three-dimensional object in which the initial texture image 100 has been embedded based on the image name of the initial texture image 100, and may identify the first dynamic region in the three-dimensional object based on the identified region and the two-dimensional position information p1 to p4 in the initial texture image 100.

As described above, according to the second embodiment, since the image 800 of the second dynamic region can be embedded in the first dynamic region 900 without using the three-dimensional position information P1 to P4, the processing load of the processor consumed for the embedding processing can be reduced.

Modifications described below can be adopted for the present disclosure.

(1) In the first and second embodiments, the markers M1 to M4 are used, but the present disclosure is not limited thereto. For example, the first dynamic region 900 and the second dynamic region may be identified in the object recognition processing. For example, in a case where the dynamic region includes a display region of a monitor (an example of an object element), the identification unit 12 may identify the display region of the monitor by applying the object recognition processing to the three-dimensional object, and may identify the identified display region of the monitor as the first dynamic region. In addition, the detection unit 13 may identify the display region of the monitor by applying the object recognition processing to the real image, and may detect the identified display region of the monitor as the second dynamic region. As the object recognition processing, a method using an object recognizer machine-learned in advance can be adopted. An example to be adopted as the object recognizer includes an object recognizer that outputs a bounding box indicating the display region of the monitor, the bounding box being superimposed on a three-dimensional object or a real image.

(2) During generating the three-dimensional object, not the image captured by the camera of the three-dimensional scanner 2 but the real image captured by the camera 3 may be adopted as the texture image to be embedded in the three-dimensional object. In this case, the acquisition unit 11 may embed the real image captured by the camera 3 in the three-dimensional model as a texture image using the markers appearing in the real image as marks.

(3) Although the distortion parameter is acquired by the camera calibration in the above embodiments, a known distortion parameter may be acquired from the memory 20.

The present disclosure is useful in the technical field of remotely assisting a site.

1. An information processing method in a computer, the method comprising:
acquiring a three-dimensional object by reproducing a real object including a dynamic region in a virtual space;
identifying a first dynamic region indicating the dynamic region in the three-dimensional object;
acquiring a real image of the real object captured by an imaging device;
detecting a second dynamic region indicating the dynamic region in the real image;
embedding an image of the second dynamic region in real time as a texture image of the first dynamic region; and
outputting a display image of the three-dimensional object in which the image of the second dynamic region has been embedded.

2. The information processing method according to claim 1, wherein
the real object has a marker indicating the dynamic region,
the identifying the first dynamic region includes detecting the first dynamic region based on the marker in the three-dimensional object, and
the detecting the second dynamic region includes detecting the second dynamic region based on an image indicating the marker included in the real image.

3. The information processing method according to claim 1, wherein
the dynamic region corresponds to an object element constituting the real object,
the identifying the first dynamic region includes identifying a region of the object element in the three-dimensional object with object recognition processing, and
the detecting the second dynamic region includes detecting a region of the object element in the real image with the object recognition processing.

4. The information processing method according to claim 1, wherein
the real image is repeatedly acquired, and
the detecting, the embedding, and the outputting of the second dynamic region are performed each time the real image is acquired.

5. The information processing method according to claim 1, wherein
the embedding the image of the second dynamic region includes
acquiring a distortion parameter of the imaging device,
correcting distortion of the image of the second dynamic region using the distortion parameter, and
embedding the image of the second dynamic region after the correcting in the first dynamic region.

6. The information processing method according to claim 5, wherein the distortion parameter is estimated by camera calibration using current position and attitude information about the imaging device, initial position and attitude information about the imaging device at a time of capturing an initial texture image embedded in the first dynamic region, two-dimensional position information about the dynamic region in the initial texture image, two-dimensional position information about the second dynamic region in the real image, and three-dimensional position information about the first dynamic region.

7. The information processing method according to claim 6, wherein the current position and attitude information about the imaging device is estimated by applying a self-position estimation algorithm to the initial texture image and the real image.

8. The information processing method according to claim 1, wherein
the embedding the image of the second dynamic region includes
editing the image of the second dynamic region to match with a shape of the first dynamic region, based on two-dimensional position information about a vertex of the second dynamic region and two-dimensional position information about a vertex of the first dynamic region, and
embedding the edited image of the second dynamic region in the first dynamic region.

9. The information processing method according to claim 1, wherein the dynamic region includes a region corresponding to a display region of a monitor included in the real object.

10. An information processing device comprising a processor,
wherein the processor
acquires a three-dimensional object by reproducing a real object including a dynamic region in a virtual space,
identifies a first dynamic region indicating the dynamic region in the three-dimensional object,
acquires a real image of the real object captured by an imaging device,
detects a second dynamic region indicating the dynamic region in the real image,
embeds an image of the second dynamic region in real time as a texture image of the first dynamic region, and
outputs a display image of the three-dimensional object in which the image of the second dynamic region has been embedded.

11. A non-transitory computer readable recording medium storing an information processing program for causing a computer to perform processing of:
acquiring a three-dimensional object by reproducing a real object including a dynamic region in a virtual space;
identifying a first dynamic region indicating the dynamic region in the three-dimensional object;
acquiring a real image of the real object captured by an imaging device;
detecting a second dynamic region indicating the dynamic region in the real image;
embedding an image of the second dynamic region in real time as a texture image of the first dynamic region; and
outputting a display image of the three-dimensional object in which the image of the second dynamic region has been embedded.
